(19) United States
(12) Patent Application Publication
(10) Pub. No.: US 2025/0157130 A1
(43) Pub. Date: May 15, 2025

(54) Distortion-Free Passthrough Rendering for Mixed Reality

(71) Applicant: Meta Platforms Technologies, LLC, Menlo Park, CA (US)

(72) Inventors: Andrey Tovchigrechko, Saratoga, CA (US); Alexander Sorkine Hornung, Zurich (CH); Sebastian Sztuk, Virum (DK); Remo Ziegler, Uster (CH); Oskar Linde, San Carlos, CA (US); Ricardo da Silveira Cabral, Zurich (CH); Alex Locher, Oberrohrdorf (CH); Anirud Thyagharajan, Zurich (CH); Artem Filatov, Thalwil (CH); Fabian Langguth, Wädenswil (CH); Ngoc Minh Dang, Basel (CH); Salah Eddine Nouri, Zurich (CH); Paul Timothy Furgale, Thalwil (CH)

(21) Appl. No.: 18/418,130

(22) Filed: Jan. 19, 2024

Related U.S. Application Data
(60) Provisional application No. 63/598,790, filed on Nov. 14, 2023.

(51) Int. Cl. G06T 15/10; G06T 5/77; G06T 7/194; G06T 7/50; G06T 19/00

(52) U.S. Cl. CPC G06T 15/10; G06T 5/77; G06T 7/194; G06T 7/50; G06T 19/006

(57) ABSTRACT

A device may access an input image of a real-world scene captured by a camera from a camera viewpoint. The device may render, from the camera viewpoint, an inpainting image of a background of the real-world scene based on a 3D reconstruction model of the background of the real-world scene, wherein the 3D reconstruction model is generated using previously-captured images and previously-generated depth estimates. The device may generate a depth estimate of the real-world scene and identify, based on the depth estimate, a first set of pixel locations and a second set of pixel locations in a passthrough image to be rendered. The device may render, from a viewpoint of an eye of a user, the passthrough image based on the input image, the inpainting image, and the depth estimate. First pixel values for the first set of pixel locations in the passthrough image are sampled from the input image, and second pixel values for the second set of pixel locations in the passthrough image are sampled from the inpainting image.

### PRIORITY

This application claims the benefit under 35 U.S.C. § 119 (e) of U.S. Provisional Patent Application No. 63/598,790, filed 14 Nov. 2023, which is incorporated herein by reference.

### TECHNICAL FIELD

This disclosure generally relates to computer graphics, and more specifically to mixed reality rendering techniques.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content, such as a mixed reality image, may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Artificial reality may be associated with applications, products, accessories, services, or some combination thereof, that are, e.g., used to create content in artificial reality and/or used in (e.g., perform activities in) an artificial reality. Artificial reality systems that provide artificial reality content may be implemented on various platforms, including a head-mounted device (HMD) connected to a host computer system, a standalone HMD, a mobile device or computing system, or any other hardware platform capable of providing artificial reality content to one or more viewers.

“Passthrough” is a feature that allows a user to see their physical surroundings while wearing an artificial reality system. Information about the user's physical environment is visually “passed through” to the user by having the headset of the artificial reality system display information captured by the headset's external-facing cameras. The visual information, which may be referred to as “passthrough,” allows the user to see their physical surroundings while wearing an HMD. Information about the user's physical environment is visually “passed through” to the user by having the HMD display information captured by the headset's external-facing cameras. Simply displaying the captured images would not work as intended, however. Since the locations of the cameras do not coincide with the locations of the user's eyes, the images captured by the cameras do not accurately reflect the user's perspective. In addition, since the images have no depth, simply displaying the images would not provide the user with proper parallax effects if he were to shift away from where the images were taken. Incorrect parallax, coupled with user motion, could lead to motion sickness.

Passthrough images are generated by reprojecting or warping images captured by cameras of an artificial-reality device toward the user's eye positions using depth measurements of the scene. An artificial-reality headset may have a left external-facing camera and a right external-facing camera. Based on depth estimates of the scene, the left image captured by the left camera is reprojected to the viewpoint of the left eye, and the right image captured by the right camera is reprojected to the viewpoint of the right eye. The reprojected images captured by the cameras, when displayed to the user, would approximate how the captured scene would have appeared had it been observed from the perspective of the user's eyes.

An inherent challenge with generating passthrough images is that the cameras physically cannot capture exactly what the user's eyes would have seen. This is because the cameras cannot be placed exactly where the user's eyes are. Due to differences in perspective between the cameras and the user's eyes, some scene information that should be observable from the user's eyes is not observable from the cameras. Such missing scene information from the captured images is especially noticeable for foreground objects that are relatively close to the user. For example, when the user's outstretched arm is within the field of view of the camera, a portion of the background would be occluded by the arm and not visible to the camera. That same portion, however, may be visible from the user's eye due to the slight difference in viewpoint. As a result, when the camera image is reprojected to the eye's viewpoint, a portion of the generated passthrough image would have missing scene information. In the example of the user's outstretched arm, a portion around the arm would not have any scene information. Traditionally, the missing information is visually obfuscated via blurring or blending. The result, however, is that the boundaries of foreground objects would appear distorted in the passthrough images.

### SUMMARY OF PARTICULAR EMBODIMENTS

In some aspects, the techniques described herein relate to methods for synthesizing passthrough images by inpainting missing information using past observations of the environment's background. The methods that may be performed by, e.g., a computing system and/or implemented as software that may be executed by a computing system. For example, a computing system may perform the following steps to generate a passthrough image: accessing an input image of a real-world scene captured by a camera of an artificial-reality headset from a camera viewpoint; rendering, from the camera viewpoint, an inpainting image of a background of the real-world scene based on a three-dimensional (3D) reconstruction model of the background of the real-world scene, wherein the 3D reconstruction model is generated using previously-captured images and previously-generated depth estimates; generating a depth estimate of the real-world scene; identifying, based on the depth estimate of the real-world scene, a first set of pixel locations and a second set of pixel locations in a passthrough image to be rendered; and rendering, from a viewpoint of an eye of a user, the passthrough image based on the input image, the inpainting image, and the depth estimate, wherein first pixel values for the first set of pixel locations in the passthrough image are sampled from the input image, and second pixel values for the second set of pixel locations in the passthrough image are sampled from the inpainting image.

In some aspects, the techniques described herein relate to a method, wherein the 3D reconstruction model is generated by: segmenting the previously-captured images and the previously-generated depth estimates into background portions and foreground portions; and generating the 3D reconstruction model based on the background portions of the previously-captured images and the previously-generated depth estimates.

In some aspects, the techniques described herein relate to a method, wherein the 3D reconstruction model excludes the foreground portions of the previously-captured images and the previously-generated depth estimates.

In some aspects, the techniques described herein relate to a method, wherein the previously-captured images and the previously-generated depth estimates are generated by the artificial-reality headset while being worn by the user.

In some aspects, the techniques described herein relate to a method, wherein the 3D reconstruction model of the background of the real-world scene includes a 3D mesh model and a corresponding texture atlas.

In some aspects, the techniques described herein relate to a method, wherein the depth estimate is generated by: capturing depth data using a depth sensor at a first frame rate; generating a densified depth map based on the depth data; and generating the depth estimate by warping the densified depth map to the camera viewpoint, wherein the depth estimate is generated at a second frame rate higher than the first frame rate.

In some aspects, the techniques described herein relate to a method, wherein the second set of pixel locations in the passthrough image lack corresponding pixel value information in the input image.

In some aspects, the techniques described herein relate to a method, wherein the 3D reconstruction model is updated at a first frame rate and the passthrough image is rendered at a second frame rate higher than the first frame rate.

In some aspects, the techniques described herein relate to a method, further including: performing color normalization of the inpainting image based on the input image before using the inpainting image to generate the passthrough image.

In some aspects, the techniques described herein relate to a method, further including: performing local alignment of one or more pixels in the inpainting image based on the input image before using the inpainting image to generate the passthrough image.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates the discrepancy between observations made from the perspective of a user's eyes compared to those made from the perspective of a headset's cameras.

FIG. 2A illustrates an example of disocclusion artifacts in a passthrough image.

FIG. 2B illustrates an example of the passthrough image shown in FIG. 2A after inpainting the missing pixel information.

FIG. 3 illustrates a view synthesis pipeline, according to particular embodiments.

FIG. 4 illustrates another example of a view synthesis pipeline, according to particular embodiments.

FIG. 5 illustrates an example of a method for synthesizing passthrough images.

FIG. 6 illustrates an example artificial-reality headset worn by a user.

FIG. 7 illustrates an example computing system that may be used to execute the techniques described herein.

### DESCRIPTION OF EXAMPLE EMBODIMENTS

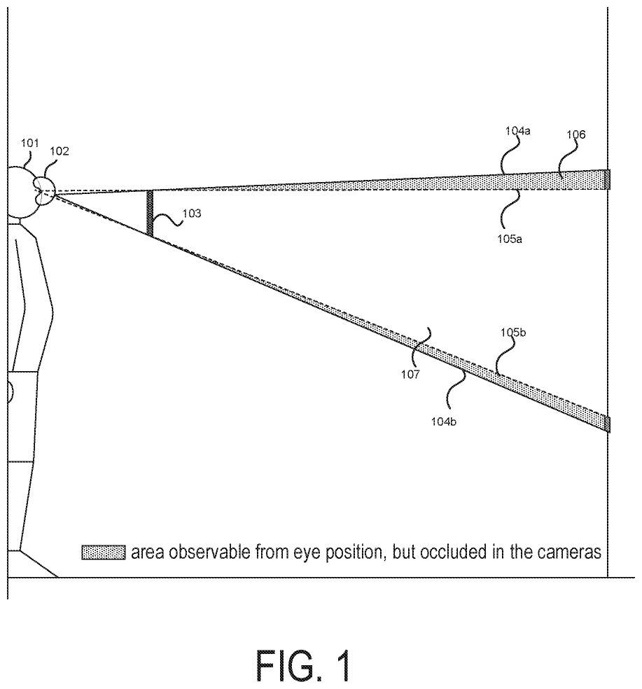

Embodiments described herein relate to an improved pipeline for rendering passthrough images that address disocclusion issues. As previously mentioned, due to differences between the locations of passthrough cameras (i.e., the cameras used for capturing images that would be warped to generate passthrough images) and the user's eyes, the captured images may have missing information once they are warped to the viewpoint of the user's eyes. FIG. 1 illustrates this issue. The headset 102 worn by user 101 has external-facing passthrough cameras. Even if those cameras are placed as close to the user's eyes as possible, there will inevitably be differences. For example, the user's eyes are a few millimeters behind the cameras, which are mounted on the surface of the headset. When the scene includes foreground objects 103, such as the user's hand, the amount of background occluded by the foreground object 103 would be noticeably different from the perspective of the passthrough cameras and the user's eyes. For example, since the foreground object 103 is closer to the passthrough camera than the user's eye, the foreground object 103 would appear relatively larger to the passthrough camera. Consequently, the foreground object 103 would occlude a larger portion of the passthrough camera's view. FIG. 1 illustrates the impact of foreground object 103 on the camera's views by drawing solid lines 104a-b from the camera on the headset 102 toward the edges of foreground object 103. The area between lines 104a-b represents the area occluded by the foreground object 103 from the perspective of the camera. FIG. 1 further illustrates the impact of foreground object 103 on the user's view by drawing dotted lines 105a-b from the user's eye toward the edges of foreground object 103. The area 107 between the dotted lines 105a-b represents the area occluded by the foreground object 103 from the perspective of the user's eye. The area 107 occluded by the foreground object 103 as seen from the perspective of the user's eye is smaller than the area occluded from the perspective of the camera (the difference is shown by the shaded area 106). Difference in occlusion observed by the camera and the user's eye is also attributable to differences in their locations in other axes as well. When the image captured by the passthrough camera is reprojected to the user's eye position, certain portions of the scene that were occluded in the image should become visible to the user, resulting in the aforementioned disocclusion problem.

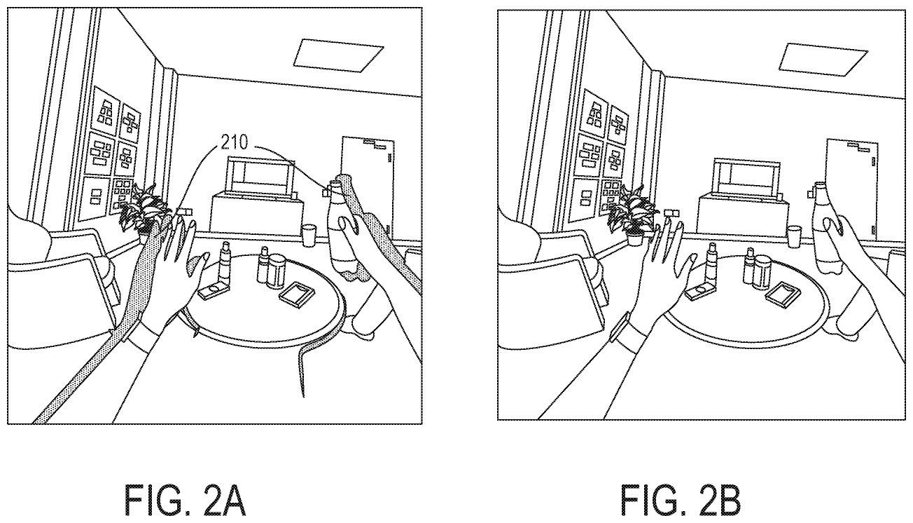

A result of the disocclusion problem is that the final passthrough image would have missing scene information. The rendering process, at a high level, starts with an image capture and a depth measurement of the scene. Using the depth measurement and the known intrinsic and extrinsic parameters of the passthrough camera, the rendering system would reproject the image to an estimated position of the user's eye, thereby generating a passthrough image of the scene as observed from the perspective of the user's eye. When the scene includes only background objects that are far away from the user, the resulting passthrough images would have high fidelity. But in the presence of foreground objects, the disocclusion problem would be more pronounced. FIG. 2A shows an example of a passthrough image of a scene where the user's hands, arms, and a bottle are foreground objects. Noticeably, the passthrough image has missing pixel information 210 around the foreground objects. If left untreated, the passthrough image would have gaps or holes, as shown in FIG. 2A. To improve the visual appearance of the passthrough image, the rendering system may perform a blending or blurring process to fill the missing pixel information using neighboring pixel information. The result, however, is that the region around foreground objects would appear distorted, which is not ideal.

Particular embodiments described herein provide an improved view synthesis method that would address the disocclusion problem. At a high level, the idea is to leverage previously captured images to provide information about the background scene that might be occluded in the current image capture. When the user puts on the headset or starts a mixed-reality session, external cameras would capture images of the user's scene. A 3D reconstruction module may scan the user's environment, gathering image data and depth measurements. In particular embodiments, the image and depth data may be filtered to separate background from foreground objects. The image and depth data associated with the background may then be used to generate a 3D model (e.g., mesh) of the background, along with a corresponding texture atlas. With the 3D model and texture atlas, the rendering system would be able to synthesize an image of the background scene from a novel viewpoint. The pixel information of the background in that synthesized image may then be used to fill in the missing pixel information in the passthrough image. FIG. 2B illustrates an example of the passthrough image shown in FIG. 2A after inpainting the missing pixel information 210.

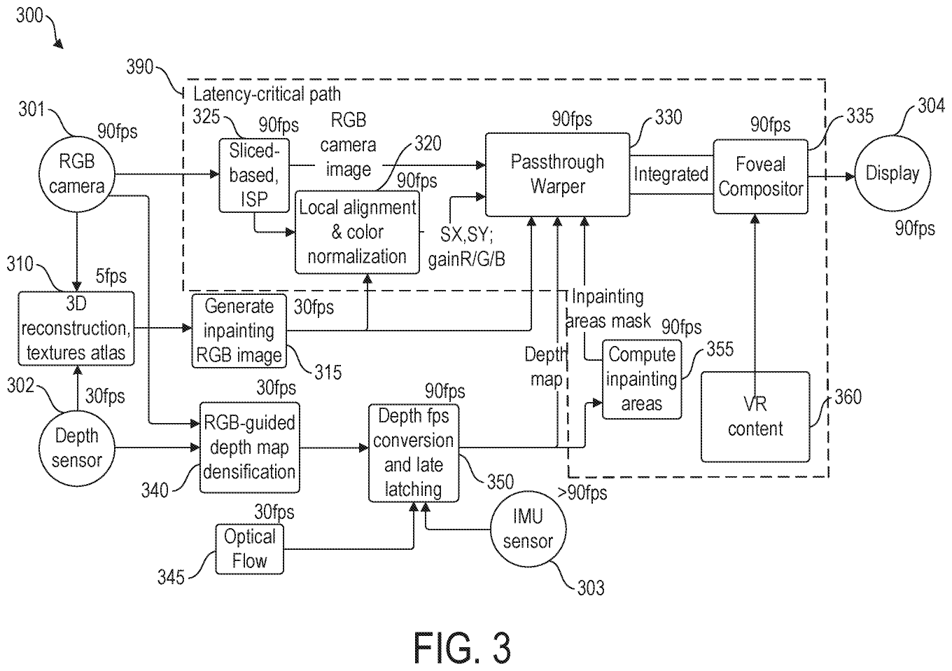

FIG. 3 illustrates a view synthesis pipeline 300 for passthrough generation, according to particular embodiments. The view synthesis pipeline 300 may be implemented on an artificial-reality headset, a compute unit tethered to an artificial-reality headset, or a server in communication with the artificial-reality headset. The artificial-reality headset may have a camera 301, which could capture color information (e.g., red, green, and blue color channels, or RGB) or monochrome brightness information. Images captured by the camera 301 would be used by the view synthesis pipeline 300 to generate a passthrough image. In particular embodiments, the camera 301 may be associated with a particular eye of the user, such as the left eye, which means that the images captured by the camera 301 would be used to generate passthrough images for the associated eye (e.g., left eye). In such an embodiment, another camera (not shown) may be associated with the user's other eye, and images captured by that camera would be used to generate passthrough images for the other eye. In other embodiments, the artificial-reality headset may only have one camera for capturing images for passthrough generation. In that case, images captured by the same camera would be used to generate passthrough images for both eyes. The artificial-reality device may also have a display 304 for each of the user's eyes (FIG. 3 shows only one display). A left-eye display (e.g., display 304) would display content intended for the user's left eye, and a right-eye display would display content intended for the user's right eye.

The artificial-reality device may be configured out output content at a particular frame rate. In the example shown in FIG. 3, the view synthesis pipeline is configured to output content at 90 frames per section (fps). However, any other suitable frame rate may be used instead. In order to generate content at the desired frame rate, portions of the pipeline 300 need to perform their respective tasks at the target output frame rate, which is 90 fps in the example shown, in order to not negatively impact output latency. FIG. 3 illustrates a dotted box to highlight modules within a latency-critical path 390. The modules are designed to perform their respective tasks at the target output framerate of, e.g., 90 fps. The modules outside of the latency-critical path 390 may perform their respective operations at a slower rate. For example, the 3D reconstruction and texture atlas module 310 may operate at 5 fps, and the inpainting generation module 315 may operate at 30 fps. Additional details of each of these modules would be provided below.

The view synthesis pipeline 300 leverages previously captured scene information to fill in missing background information in the current frame associated with time to. In particular embodiments, the camera 301 of the artificial-reality headset may capture images at a frame rate of, e.g., 90 fps, and a depth sensor (e.g., time-of-flight sensor, stereo depth sensor, etc.) 302 may generate depth estimates for the scene at a relatively slower rate, such as 30 fps. These frame rates are provided as an example only; one of ordinary skill in the art would recognize that other frame rates could be used instead, and that the depth sensor 302 could operate at the same rate as the camera 301 in some embodiments. A computing system may process past image and depth data (e.g., associated with time t₀−1, t₀−2, etc.) captured by the camera 301 and depth sensor 302 to generate a 3D reconstruction and corresponding texture atlas for the background scene. As illustrated, such a 3D reconstruction module 310 may operate at a significantly slower rate (e.g., 5 fps) relative to the output frame rate (e.g., 90 fps). The 3D reconstruction module 310, in one embodiment, may use conventional machine-learning-based scene segmentation techniques to process an image captured by the camera 301 and identify the background pixels. The segmentation information may then be used to extract or filter depth measurements captured by the depth sensor 302 to isolate those that correspond to background objects. The 3D reconstruction module 310 may then generate a mesh of the background scene using the depth measurements associated with background objects. The 3D reconstruction module 310 may further generate a texture atlas for the mesh by mapping the mesh to the background pixel information identified in the image. In particular embodiments, the mesh and/or the texture atlas may be refined over time using additional image and depth captures. In the example shown in FIG. 3, the 3D mesh and corresponding texture atlas may be updated at, e.g., 5 fps.

At a high-level, the view synthesis pipeline 300 prepares three pieces of information before warping the input image at t₀ to generate a passthrough image: (1) the current image captured by camera 301 at time t₀, (2) an inpainting image used for inpainting missing background information, and (3) identification of areas in the passthrough image that would require inpainting. Each of these will be described in turn.

At time t₀, the artificial-reality device may capture an input image using the camera 301, which may do so at 90 fps. In particular embodiments, the captured image data may be processed by an Image Signal Processor (ISP) 325 and output slice by slice, where each slice corresponds to a portion of the rows of the captured image (e.g., if the captured image has 1000 rows, a slice may have 100 rows of pixels). In other embodiments, the ISP may output the entire image at once. The number of rows output by the ISP depends in part on the throughput of the ISP and the desired frame rate of the latency-critical path 390. For ease of discussion, the output of the ISP is referred to as an image capture, even though in some embodiments it may be only a slice of the entire capture. The image would then be provided to a passthrough warper 330, which will be described in further detail below.

As previously explained, due to location differences between the camera 301 and the user's eye, warping the image captured at time t₀ to the point of view of the user's eye may result in certain portions of the final passthrough image having missing information, especially when foreground objects are present. Thus, in particular embodiments, the view synthesis pipeline 300 leverages past sensory captures to generate an inpainting image 315 of the background without the present foreground objects. For example, if the image captured at time to includes the user's arm in front of a background (e.g., the user's room), the inpainting image 315 would include only the background (e.g., the user's room) and not the user's arm. An inpainting image 315 may be implemented using any suitable data structure, including an image with multiple color channels, a layered representation (e.g., each background object may have its own layer), etc. In particular embodiments, the inpainting image 315 may be rendered using the last 3D mesh and texture atlas generated by the 3D reconstruction module 310. The inpainting image 315 may be rendered from the viewpoint of the latest estimated camera pose of the camera 301. Notably, since the rendering process may take more time than the frame rate of the latency-critical path 390, the inpainting image 315 may be generated at a slower rate. In the example shown in FIG. 3, the inpainting image 315 is generated at 30 fps, whereas the latency-critical path is operating at 90 fps.

In particular embodiments, an inpainting image 315 generated at a slower rate may need to be adjusted to account for differences in the camera viewpoint used for rendering the inpainting image 315 and the current viewpoint of the camera 301 at time to. In addition, since the inpainting image 315 is generated using past texture data, the color and/or brightness of the background scene may be different from the current scene at time to. Thus, in particular embodiments, the view synthesis pipeline 300 may use an image-adjustment module 320 to perform local alignment and color normalization of the inpainting image 315. The goal of the module 320 is to adjust the inpainting image 315 so that it approximates what the background of the scene looks like at time to and from the camera pose at time to. The image-adjustment module 320 may take as input the current image at time to and the inpainting image 315. In particular embodiments, the module 320 may further take into account the estimated viewpoint of the camera 301 when taking the current image and the viewpoint used to render the inpainting image 315. The module 320 may then compute the local alignment and/or color normalization for the inpainting image 315 based on these inputs. The output of the module 320, in particular embodiments, is a per-pixel local alignment factor (e.g., SX and SY), which specifies amounts that the associated pixel needs to shift in the X and Y directions. For each pixel, the module 320 may also output a color normalization scaling factor (e.g., gain R, G, B) to be applied to the associated pixel in the inpainting image 315.

The image-adjustment module 320 may use optical flow techniques to find correspondences between the input image from the ISP 325 and the inpainting image 315. However, since the inpainting image 315 only has the background scene and the input image from the ISP 325 may contain foreground objects, the image-adjustment module 320 would need to first identify pixels in the input image that correspond to background objects (e.g., via machine-learning based image segmentation techniques). Then, the image-adjustment module 320 may compute optical flow to find correspondences between pixels in the inpainting image 315 and background pixels in the input image. The optical flow information may be used to determine the local alignment adjustments. This process would generate local alignment factors for pixels in the inpainting image 315 that have correspondences in the input image, but not for portions of the inpainting image 315 that have no correspondence in the input image, which could occur because those portions of the background are occluded by foreground objects in the input image. Thus, in particular embodiments, the image-adjustment module 320 may apply interpolation on the known local alignment factors to derive local alignment factors for portions of the in-painting image 315 that have no correspondence in the input image. In particular embodiments, the interpolation technique used could be a smoothing interpolation, where the local alignment factor for each occluded background pixel in the inpainting-image 315 is interpolated from one or more known local alignment factors of one or more of the closest pixels, weighted by pixel distance (e.g., the local alignment factor from a closer pixel is more highly weighted than the local alignment factor from a relatively farther pixel). Finally, the correspondence information and/or local alignment factors, which inform the module 320 of pixel correspondences between the inpainting image 315 and the input image, may be used to generate color/brightness normalization factors for each pixel of the inpainting image 315. The local alignment factors and the color/brightness normalization factors may then be used to adjust pixels in the inpainting image 315 to generate an adjusted inpainting image. In the embodiment shown in FIG. 3, the local alignment factors and color/brightness normalization from module 320 may be sent to the passthrough warper 330, which in turn would use the received information to adjust the inpainting image 315 to generate a corresponding adjusted inpainting image. In other embodiments, the adjusted inpainting image may be pre-generated before being sent to the passthrough warper 330.

The passthrough warper 330 may use the adjusted inpainting image, as described above, to fill in information missing in the input image. The input image and the adjusted inpainting image both represent the scene at time to as observed from the perspective of the camera 301 at time t₀, except that the input image includes both foreground and background objects, whereas the adjusted inpainting image only includes background objects. The passthrough warper 330 would selectively sample from the input image, the adjusted inpainting image, or a mixture of both in order to obtain the information needed to generate a complete passthrough image. To know which image to sample from, the passthrough warper 330 would also need to know the locations of disocclusion pixels, which refers to pixels in the passthrough image that are not observed in the image captured by the camera 301.

Identification of disocclusion pixels may be based on the scene's depth information. In particular embodiments, the depth sensor 302 may generate a sparse depth measurement, which may be generated at a slower rate (e.g., 30 fps) than the latency-critical path 390. The depth measurements may be densified by a depth densification module 340, according to particular embodiments. In particular embodiments, an image captured at substantially the same time as the depth measurements may be used to densify the depth measurements. For example, a machine-learning model may be trained to take as input an image and a corresponding sparse depth map of a scene. The machine-learning model may output interpolation kernels for each pixel in the densified depth map. The interpolation kernels may be applied to the sparse depth map to generate an interpolated depth value for each pixel in the densified depth map. During training, the densified depth map may be compared to a ground-truth depth map. Results of the comparison may be computed using one or more loss functions (e.g., L1 loss, VGG loss, etc.) and backpropagated to the machine-learning model to update its weights. After a certain number of training iterations or after a predetermined terminating condition is met, training would terminate. Once trained, the machine-learning model may be used to process a given sparse depth map with a corresponding image of a scene and output a densified depth map. While one example of a densification technique for depth maps is described, it should be understood that this disclosure is not limited to any particular technique for densifying depth maps.

Since the depth map may be generated at a slower frame rate (e.g., 30 fps) than the latency-critical path 390, the depth map may no longer be aligned with the current perspective of the user at time to. As such, in particular embodiments, the depth map from the densification module 340 may be adjusted by a depth-adjustment module 350 to account for late latching. In particular embodiments, the depth-adjustment module 350 may operate at the same rate as the latency-critical path (e.g., 90 fps) so that the adjusted depth map may be used by the passthrough warper to generate passthrough images. In particular embodiments, the depth-adjustment module 350 may use an IMU sensor 303 of the artificial-reality device to estimate movement of the headset since the time when depth was measured by the depth sensor 302. In addition, the depth-adjustment module 350 may use optical flow information 345, which may be generated at a relatively slower rate (e.g., 30 fps), to account for motion. The depth-adjustment module may use the optical flow 345 to generate an adjusted depth map for the current frame to, which represents the depth of the scene as observed from the current perspective of the camera 301.

Areas in the passthrough image that would need inpainting could be computing using the adjusted depth map from the depth-adjustment module 350. In particular embodiments, an inpainting detection module 355 may be used to generate an inpainting area mask. The mask may have pixels corresponding to pixels in the passthrough image, and each pixel in the mask may indicate whether color information for that pixel should be sampled from the input image (i.e., the pixel information is captured in the input image) or the adjusted inpainting image (i.e., the pixel information is not captured in the input image and, as a result, inpainting is needed). In particular embodiments, the inpainting detection module 355 may generate an inpainting area mask according to the timing of the latency-critical path (e.g., 90 fps). The inpainting detection module 355 may be integrated within the same hardware block as the passthrough warper 330 or operate as a separate hardware unit.

The inpainting detection module 355 may generate an inpainting area mask based on the adjusted depth map. The adjusted depth map, which represents the depth of the current scene (both foreground and background objects), can be used to compute which pixels in the passthrough image does not have corresponding color information in the input image. For example, in particular embodiments, the input image may be reprojected to the viewpoint of the user's eye using the adjusted depth map. Any pixel in the resulting reprojected image that has corresponding color information from the input image would be flagged as, e.g., 1 to indicate that color information for that pixel is available in the input image. Any pixel in the resulting reprojected image that has no corresponding color information from the input image would be flagged as, e.g., 0, to indicate that color information for that pixel is missing in the input image and, therefore, should be obtained from the adjusted inpainting image. The resulting inpainting area mask may then be provided to the passthrough warper 330.

The passthrough warper 330, once obtained the inpainting area mask, may generate a passthrough image. As previously discussed, the passthrough warper 330 may have access to an input image captured by the camera 301, an adjusted inpainting image (generated by adjusting the inpainting image 315 using local alignment and color normalization factors from module 320), an adjusted depth map of the current scene, and an inpainting area mask. When rendering each pixel of the passthrough image, the passthrough warper 330 may use the inpainting areas mask to determine whether color information for the pixel should be sampled from the input image or the adjusted inpainting image. In the former case, the passthrough warper 330 could determine a portion of the adjusted depth map that is visible to the current pixel in the passthrough image and sample a corresponding portion in the input image to derive the color information for the current pixel. If instead the inpainting area mask indicates that color information should be obtained from the adjusted inpainting image, the passthrough warper could determine a portion of the adjusted depth map that is visible to the current pixel in the passthrough image and sample a corresponding portion in the adjusted inpainting image to derive the color information for the current pixel. In particular embodiments, the inpainting area mask may support blending of the input image and the adjusted inpainting image. For example, instead of a binary value, each pixel in the mask could contain a value between 0 and 1. For example, if the value of a current pixel in the mask is 0.3, it may indicate that 30% of the color information for that pixel should be sampled from the input image, and the remaining 70% of the color information for that pixel should be sampled from the adjusted inpainting image. In this manner, every pixel in the passthrough image would be generated using either information from the input image or the inpainting image. As such, there would be no missing information that needs to be filled via blending or blurring.

The passthrough image may then be passed to a foveal compositor 335. The foveal compositor 335 is tasked with compositing the passthrough image with one or more virtual content 360 that the system wishes to display to the user to create a mixed-reality scene. The foveal compositor may operate at the same rate as the latency-critical path to output final images at the desired frame rate (e.g., 90 fps). The final composited image may then be output to the display 304.

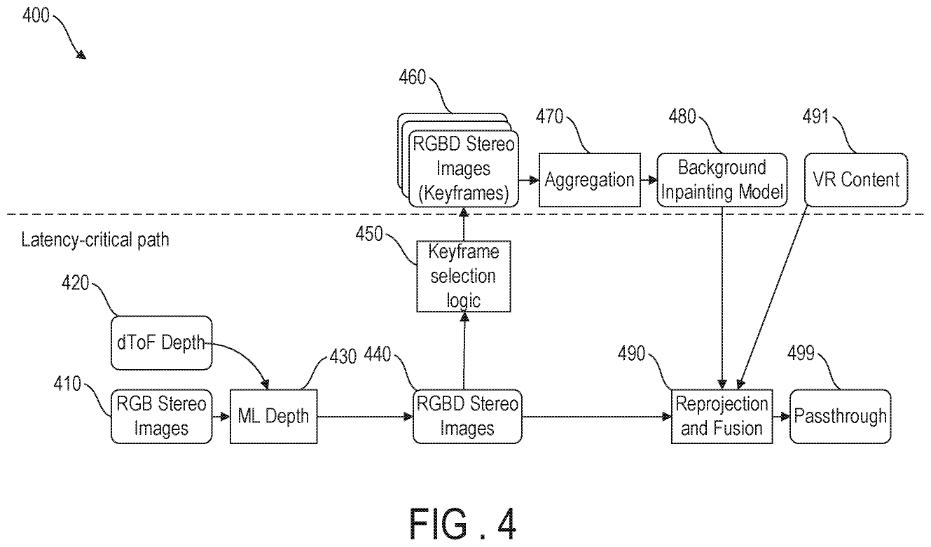

FIG. 4 illustrates another example of a view synthesis pipeline 400, according to particular embodiments. Instead of using past observations to build a 3D mesh model of the background environment, view synthesis pipeline 400 relies on RGBD keyframes for inpainting. View synthesis pipeline 400 may have a latency-critical path of processing modules that are configured to operate at a sufficiently high rate to support the desired output frame rate. For example, in FIG. 4, the processing modules shown below the dotted line are configured to operate at substantially the same frequency as the passthrough output, which may be 90 fps, for example. Other portions of the pipeline 400 that are outside of the latency-critical path (e.g., the modules shown above the dotted line) may operate at one or more lower frequencies, such as 30 fps, 60 fps, etc. Although FIG. 4 shows a particular configuration of processing modules being inside or outside of the latency-critical path, this disclosure contemplates other configurations as well. For example, the process for generating RGBD images (including RGB images 410 capture, depth 420 capture, ML depth processing 430), may be outside of the latency-critical path and operate at a frequency that is lower than 90 fps.

In particular embodiments, one or more cameras of a user's HMD 104 may capture RGB stereo images 410 of the user's environment. As will be described in further detail, the view synthesis pipeline 400 may use the currently captured RGB images 410 to generate passthrough images 499 and use a collection of past RGB images 410 to perform inpainting. At substantially the same time, a direct time-of-flight (dToF) depth sensor may synchronously measure depth 420 of the environment. While the embodiment shown in FIG. 4 uses a dToF depth sensor, other embodiments may use other techniques for estimating depth. For example, stereo-depth estimation techniques may be used instead.

RGB images 410 and depth data 420 may be combined to generate RGBD images 440 (e.g., each RGBD image may be implemented as a four-channel matrix having a red channel, a green channel, a blue channel, and a depth channel). In particular embodiments, view synthesis pipeline 400 may optionally improve and/or densify the captured depth data 420 using machine learning. For example, a machine-learning densification module 430 may be configured to process the RGB images 410 and depth data 420 to generate densified RGBD images 440.

In particular embodiments, a keyframe selection logic module 450 may process RGBD images 440 to select those that are suitable to be used for inpainting background content for subsequent frames. The selected RGBD images 440, which may be referred to as keyframes, are saved over time into a collection 460. Similar to the 3D mesh reconstruction of the background described with reference to FIG. 3, the collection of keyframes 460 represents historical observations of the background from different viewpoints. As such, each selected keyframe 460 would ideally contain only background and no foreground objects. Thus, the keyframe selection logic module 450 may be tasked with analyzing each incoming RGBD image 440 and finding those that only contain background content. In some use cases, however, it may be difficult to find RGBD images 440 that are free of foreground objects. As such, in particular embodiments, the criteria for selecting keyframes may be relaxed to also include RGBD images 440 that predominantly include background content.

Keyframe selection logic module 450 may be configured to separate foreground objects from background objects. The separation may be based on depth information in the RGBD images 440 and/or use a machine-learning model trained to automatically discern foreground objects from background objects. For example, keyframe selection logic module 450 may process RGBD images 440 and generate a segmentation mask that specifics whether each pixel in a RGBD image 440 belongs to the foreground or background. Keyframe selection module 450 may then select RGBD images 440 that have sufficient background information needed for inpainting background content. For example, keyframe selection module 450 may base its selection on the percentage of pixels in the RGBD images 440 that depict the background. The percentage may be compared to a threshold percentage (e.g., greater than 80%, 90%, 99%, or 100%) or other suitable criteria to determine whether the RGBD images 440 include sufficient background information. The keyframe selection module 450 may also take into consideration the location of background information within each RGBD image 440. For example, keyframe selection module 450 may prefer RGBD images 440 which depict background information closer to its center region. This may be implemented by weighing background pixels based on their location within the image 440. For example, background pixels that are closer to the center may be weighed more heavily than background pixels that are farther away. The weighted background pixels may then be used to determine whether to select the image 440 as a keyframe 460. In particular embodiments, keyframe selection module 450 may also take into consideration other factors. For example, each RGBD image 440 and selected keyframe 460 may be associated with a camera pose or viewpoint from which the image was captured. Based on the camera poses or viewpoints, keyframe selection module 450 may consider the spatial distribution of the existing keyframes and select new keyframes that would improve the spatial distribution of keyframe collection 460. For example, keyframe selection module 450 may add a new RGBD image 440 to keyframe collection 460 if the camera pose or viewpoint associated with the new RGBD image 440 is in a spatial region that is under-represented in the keyframe collection 460. Conversely, if the camera pose or viewpoint of a particular RGBD image 440 is already well represented in the keyframe collection 460, the keyframe selection module 450 may choose to not add the RGBD image 440 as a keyframe. In particular embodiments, keyframe selection module 450 may also consider whether keyframes in the collection 460 are stale based on their corresponding timestamps, which represent the time at which the keyframe was captured. Keyframe selection module 450 may replace stale keyframes with newer keyframes captured from substantially the same camera poses or viewpoints. Through this process, keyframe selection module 450 may keep the background information captured by the keyframe collection 460 up to date.

As previously mentioned, passthrough images are rendered for the viewpoints of the user's eyes. For the current frame, view synthesis pipeline 400 uses a reprojection and fusion module 490 to reproject the current RGBD images 440, captured from the perspectives of the cameras to the viewpoints of the user's eyes. The module 490 reprojects RGB color information of each RGBD image 440 to the viewpoint of an eye using depth information in the RGBD image 440. The reprojected image may include missing background information, as shown in FIG. 2A, due to differences between the perspectives of the cameras and the user's eyes.

To inpaint the missing background information, view synthesis pipeline 400 leverages background information previously captured by the collection of keyframes 460. The view synthesis pipeline 400 aggregates 470 one or more of the keyframes 460 captured from viewpoints that are within a threshold distance to the desired viewpoint of the user's eye. The view synthesis pipeline 400 may use a background inpainting model 480 to render background content from the perspective of the desired viewpoint of the user's eye. The background inpainting model 480 may use any suitable rendering technique, such as point-cloud-based rendering, neural volumetric rendering, weighted key-frame rendering, etc., to render an image of the background using the aggregated keyframes provided by the aggregation module 470. Reprojection and fusion module 490 may then extract relevant portions from the background image to inpaint the reprojected passthrough image. For example, the missing portion 210 shown in FIG. 2A may be inpainted using corresponding portions from the background image generated by the background inpainting module 480. In particular embodiments, reprojection and fusion module 490 may further combine VR content 491 to generate the final passthrough output 499.

Another way to leverage previously captured information to inpaint background content is by forward projecting previously generated passthrough image. For example, when generating a passthrough image for the current frame at time t, the computing system may have accumulated several past passthrough images generated within a sliding window of n frames (e.g., the past passthrough images are associated with times t−1, t−2, . . . , t−n). One or more of the past passthrough images may be projected forward to time t using optical flow. The missing background in the current frame may be extracted from the forward-projected passthrough images.

In particular embodiments, missing background content in the current passthrough image may be inpainted directly using a per-frame inpainting machine-learning model trained to inpaint passthrough images. The per-frame inpainting machine-learning model in this case does not leverage previously captured information.

In particular embodiments, one or more of the inpainting techniques described herein may be used to inpaint background content. For example, background images may be generated using any combination of pipeline 300 (3D reconstruction-based), pipeline 400 (keyframe-based), and/or forward projection of previous passthrough images. If any portion of the missing background content in the current passthrough image cannot be obtained from the background images, the system may use the previously mentioned per-frame inpainting machine-learning model to fill in the blanks.

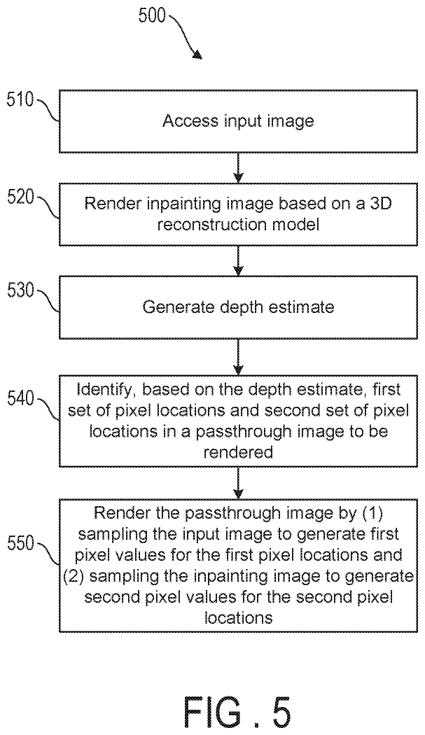

FIG. 5 illustrates an example of a method for synthesizing passthrough images. At step 510, a computing system associated with an artificial-reality device, may access an input image of a real-world scene captured by a camera of an artificial-reality headset from a camera viewpoint. At step 520, the computing system may render, from the camera viewpoint, an inpainting image of a background of the real-world scene based on a three-dimensional (3D) reconstruction model of the background of the real-world scene, wherein the 3D reconstruction model is generated using previously-captured images and previously-generated depth estimates. At step 530, the computing system may generate a depth estimate of the real-world scene. At step 540, the system may identify, based on the depth estimate of the real-world scene, a first set of pixel locations and a second set of pixel locations in a passthrough image to be rendered. At step 550, the system may render, from a viewpoint of an eye of a user, the passthrough image based on the input image, the inpainting image, and the depth estimate, wherein first pixel values for the first set of pixel locations in the passthrough image are sampled from the input image, and second pixel values for the second set of pixel locations in the passthrough image are sampled from the inpainting image.

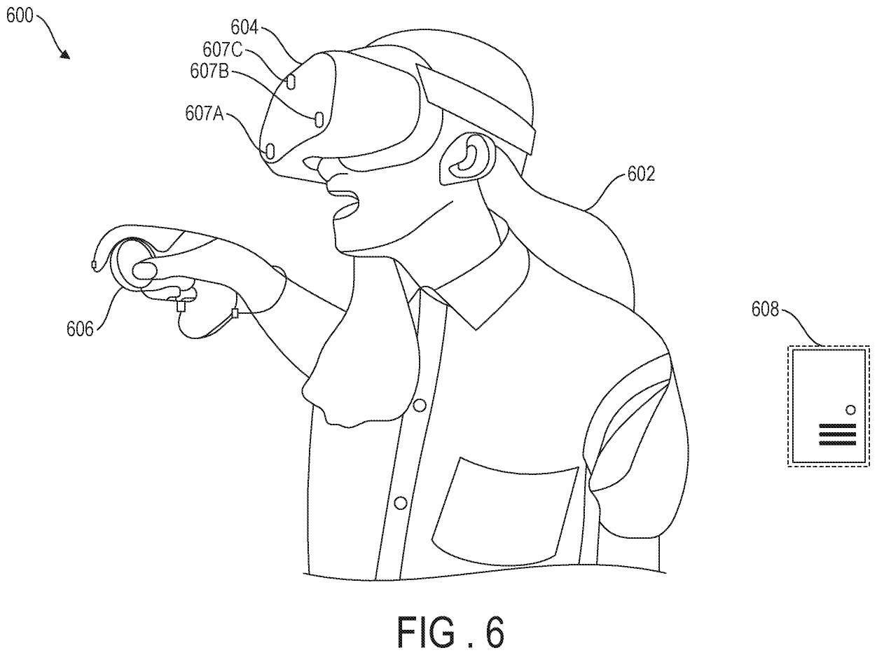

FIG. 6 illustrates an example of an artificial reality system 600 worn by a user 602. In particular embodiments, the artificial reality system 600 may comprise a head-mounted device (“HMD”) 604, a controller 606, and a computer 608. The HMD 604 may be worn over the user's eyes and provide visual content to the user 602 through internal displays (not shown). The HMD 604 may have two separate internal displays, one for each eye of the user 602. As illustrated in FIG. 4, the HMD 604 may completely cover the user's field of view. By being the exclusive provider of visual information to the user 602, the HMD 604 achieves the goal of providing an immersive artificial-reality experience. One consequence of this, however, is that the user 602 would not be able to see the physical environment surrounding him, as the user's vision is shielded by the HMD 604. As such, the passthrough feature described herein is needed to provide the user with real-time visual information about the user's physical surroundings. The HMD 604 may comprise several external facing cameras 607A-607C. In particular embodiments, the cameras 607A and 607B may be monochrome cameras while the camera 607C may be a color camera. In other embodiments, cameras 607A and 607B may be color cameras. The 607A camera may be used to generate passthrough image for the user's right eye, and the 607B camera may be used to generate passthrough image for the user's left eye. In particular embodiments, the HMD 604 may further include a depth sensor (e.g., time-of-flight or stereo).

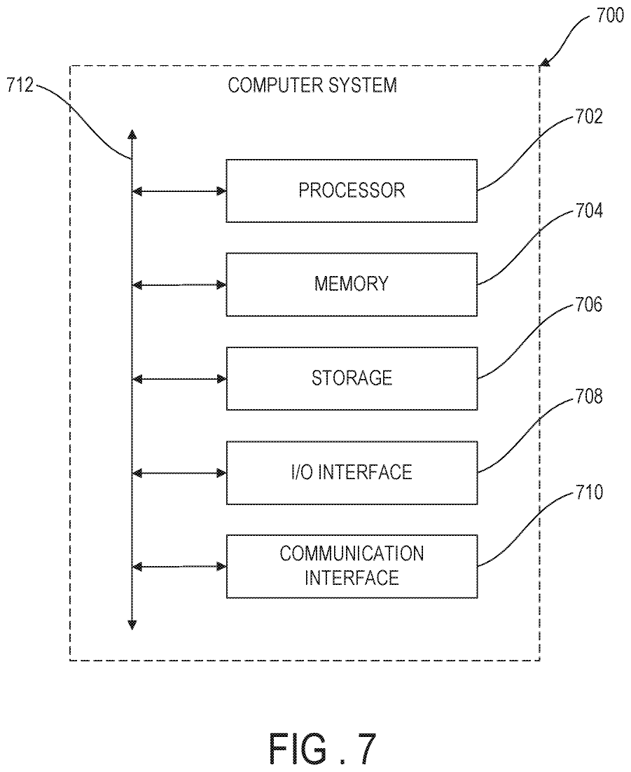

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
accessing an input image of a real-world scene captured by a camera of an artificial-reality headset from a camera viewpoint;
rendering, from the camera viewpoint, an inpainting image of a background of the real-world scene based on a three-dimensional (3D) reconstruction model of the background of the real-world scene, wherein the 3D reconstruction model is generated using previously-captured images and previously-generated depth estimates;
generating a depth estimate of the real-world scene;
identifying, based on the depth estimate of the real-world scene, a first set of pixel locations and a second set of pixel locations in a passthrough image to be rendered; and
rendering, from a viewpoint of an eye of a user, the passthrough image based on the input image, the inpainting image, and the depth estimate, wherein first pixel values for the first set of pixel locations in the passthrough image are sampled from the input image, and second pixel values for the second set of pixel locations in the passthrough image are sampled from the inpainting image.

2. The method of claim 1, wherein the 3D reconstruction model is generated by:
segmenting the previously-captured images and the previously-generated depth estimates into background portions and foreground portions; and
generating the 3D reconstruction model based on the background portions of the previously-captured images and the previously-generated depth estimates.

3. The method of claim 2, wherein the 3D reconstruction model excludes the foreground portions of the previously-captured images and the previously-generated depth estimates.

4. The method of claim 1, wherein the previously-captured images and the previously-generated depth estimates are generated by the artificial-reality headset while being worn by the user.

5. The method of claim 1, wherein the 3D reconstruction model of the background of the real-world scene comprises a 3D mesh model and a corresponding texture atlas.

6. The method of claim 1, wherein the depth estimate is generated by:
capturing depth data using a depth sensor at a first frame rate;
generating a densified depth map based on the depth data; and
generating the depth estimate by warping the densified depth map to the camera viewpoint, wherein the depth estimate is generated at a second frame rate higher than the first frame rate.

7. The method of claim 1, wherein the second set of pixel locations in the passthrough image lack corresponding pixel value information in the input image.

8. The method of claim 1, wherein the 3D reconstruction model is updated at a first frame rate and the passthrough image is rendered at a second frame rate higher than the first frame rate.

9. The method of claim 1, further comprising:
performing color normalization of the inpainting image based on the input image before using the inpainting image to generate the passthrough image.

10. The method of claim 1, further comprising:
performing local alignment of one or more pixels in the inpainting image based on the input image before using the inpainting image to generate the passthrough image.

11. One or more computer-readable non-transitory storage media embodying software that is operable when executed to:
access an input image of a real-world scene captured by a camera of an artificial-reality headset from a camera viewpoint;
render, from the camera viewpoint, an inpainting image of a background of the real-world scene based on a three-dimensional (3D) reconstruction model of the background of the real-world scene, wherein the 3D reconstruction model is generated using previously-captured images and previously-generated depth estimates;
generate a depth estimate of the real-world scene;
identify, based on the depth estimate of the real-world scene, a first set of pixel locations and a second set of pixel locations in a passthrough image to be rendered; and
render, from a viewpoint of an eye of a user, the passthrough image based on the input image, the inpainting image, and the depth estimate, wherein first pixel values for the first set of pixel locations in the passthrough image are sampled from the input image, and second pixel values for the second set of pixel locations in the passthrough image are sampled from the inpainting image.

12. The one or more computer-readable non-transitory storage media of claim 11, wherein the software is further operable when executed to:
segment the previously-captured images and the previously-generated depth estimates into background portions and foreground portions; and
generate the 3D reconstruction model based on the background portions of the previously-captured images and the previously-generated depth estimates.

13. The one or more computer-readable non-transitory storage media of claim 12, wherein the 3D reconstruction model excludes the foreground portions of the previously-captured images and the previously-generated depth estimates.

14. The one or more computer-readable non-transitory storage media of claim 11, wherein the 3D reconstruction model of the background of the real-world scene comprises a 3D mesh model and a corresponding texture atlas.

15. The one or more computer-readable non-transitory storage media of claim 11, wherein the software is configured when executed to update the 3D reconstruction model at a first frame rate and render the passthrough image at a second frame rate higher than the first frame rate.

16. A system comprising:
one or more non-transitory computer-readable storage media embodying instructions; and
one or more processors coupled to the one or more non-transitory computer-readable storage media and operable to execute the instructions to:
access an input image of a real-world scene captured by a camera of an artificial-reality headset from a camera viewpoint;
render, from the camera viewpoint, an inpainting image of a background of the real-world scene based on a three-dimensional (3D) reconstruction model of the background of the real-world scene, wherein the 3D reconstruction model is generated using previously-captured images and previously-generated depth estimates;
generate a depth estimate of the real-world scene;
identify, based on the depth estimate of the real-world scene, a first set of pixel locations and a second set of pixel locations in a passthrough image to be rendered; and
render, from a viewpoint of an eye of a user, the passthrough image based on the input image, the inpainting image, and the depth estimate, wherein first pixel values for the first set of pixel locations in the passthrough image are sampled from the input image, and second pixel values for the second set of pixel locations in the passthrough image are sampled from the inpainting image.

17. The system of claim 16, wherein the one or more processors are further operable to execute the instructions to:
segment the previously-captured images and the previously-generated depth estimates into background portions and foreground portions; and
generate the 3D reconstruction model based on the background portions of the previously-captured images and the previously-generated depth estimates.

18. The system of claim 17, wherein the 3D reconstruction model excludes the foreground portions of the previously-captured images and the previously-generated depth estimates.

19. The system of claim 16, wherein the 3D reconstruction model of the background of the real-world scene comprises a 3D mesh model and a corresponding texture atlas.

20. The system of claim 16, wherein the software is configured when executed to update the 3D reconstruction model at a first frame rate and render the passthrough image at a second frame rate higher than the first frame rate.
